(19) United States
(12) Patent Application Publication
(10) Pub. No.: US 2019/0368632 A1
(43) Pub. Date: Dec. 5, 2019

(54) EVENT MONITORING SOLENOID ACTUATOR, SYSTEM, AND METHOD

(71) Applicants: Ian Charles Stumpe, Pewaukee, WI (US); Brett G. Berger, Hartford, WI (US); Patrick Thomas Schwobe, Jackson, WI (US)

(72) Inventors: Ian Charles Stumpe, Pewaukee, WI (US); Brett G. Berger, Hartford, WI (US); Patrick Thomas Schwobe, Jackson, WI (US)

(73) Assignee: TLX Technologies, LLC, Pewaukee, WI (US)

(21) Appl. No.: 16/429,985

(22) Filed: Jun. 3, 2019

Related U.S. Application Data
(60) Provisional application No. 62/680,882, filed on Jun. 5, 2018.

(51) Int. Cl. F16K 37/00; F16K 27/02

(52) U.S. Cl. CPC F16K 37/0083; H04L 12/2803; F16K 27/029

(57) ABSTRACT

An event monitoring solenoid, system, and method are provided. Such a solenoid includes a housing with a coil acting upon an armature of the solenoid. The solenoid also includes an event monitoring module situated locally within the solenoid. The event monitoring module is operable to monitor one or more operational states of the solenoid. The event monitoring module is also operable to wirelessly transmit information relating to these one or more operational states to a remote user application. A system constructed in accordance with this invention includes the solenoid, a device connected to the solenoid, and the remote user application.

### CROSS-REFERENCE TO RELATED PATENT APPLICATION

This patent application claims the benefit of U.S. Provisional Patent Application No. 62/680,882, filed Jun. 5, 2018, the entire teachings and disclosure of which are incorporated herein by reference thereto.

### FIELD OF THE INVENTION

This invention generally relates to mechanical actuators, and more particularly to solenoid actuators.

### BACKGROUND OF THE INVENTION

Solenoids are used in a variety of applications including but not limited to building systems control, e.g. air flow control, fire suppression system control, etc. Contemporary applications may include a number of solenoids connected to a common control panel. This control panel may monitor the operational state of the solenoids, e.g. whether the solenoids are in an actuated or non-actuated position, whether the solenoids are fully installed on the device they will actuate, etc.

While the above configuration has proven generally beneficial for safety and control purposes, it is not without its drawbacks. First, the above configuration requires each solenoid to be connected to the control panel so that the control panel can perform the above functionality. In systems with a large number of solenoids, this can lead to an undesirable amount of wiring and connections.

Second, such systems typically only monitor the current state of the solenoids in the system, e.g. their operational position and/or whether they are fully installed. While such functionality is helpful, it does not provide a log or detailed information of historical event data of each solenoid.

Accordingly, there is a need in the art for a solenoid actuator which provides event monitoring locally at the solenoid. The invention provides such a solenoid actuator. These and other advantages of the invention, as well as additional inventive features, will be apparent from the description of the invention provided herein.

### BRIEF SUMMARY OF THE INVENTION

In one aspect, the invention provides an event monitoring solenoid. An embodiment of such an event monitoring solenoid includes a housing with a coil carried by the housing. The event monitoring solenoid also includes an armature movable relative to the housing. The event monitoring solenoid also includes an event monitoring module situated on the housing. The event monitoring module is configured to monitor and record information relating to at least one operational state of the solenoid in a local memory element of the event monitoring module.

In an embodiment according to this aspect, the event monitoring solenoid also includes a connection detection arrangement. The at least one operational state comprises an installation state of the event monitoring solenoid. The connection detection arrangement is in operable communication with the event monitoring module to communicate information indicative of the installation state of the event monitoring solenoid.

The event monitoring module includes an installation supervision monitor. The installation supervision monitor is in operable communication with the connection detection arrangement to receive information sent by the connection detection arrangement. In certain embodiments, the connection detection arrangement can include a plunger switch or a pressure sensitive film.

In an embodiment according to this aspect, the event monitoring solenoid also includes an armature detection arrangement. The at least one operational state includes a position of the armature. The armature detection arrangement is in operable communication with the event monitoring module to communicate information indicative of the position of the armature of the event monitoring solenoid. The event monitoring module can include a firing pin state monitor. The firing pin state monitor is in operable communication with the armature detection arrangement. In certain embodiments, the armature detection arrangement can include one of a plunger switch or a force sensor.

In an embodiment according to this aspect, the event monitoring module also includes a coil voltage monitor and a coil current monitor, each of which are configured to monitor the electrical power supplied to the coil. The event monitoring module can also include at least one of a mechanical shock monitor and an ambient temperature sensor.

In an embodiment according to this aspect, the event monitoring module includes a wireless transmitter. The wireless transmitter is configured to transmit information relating to the operational state wirelessly to a remote user application.

In an embodiment according to this aspect, the local memory is non-volatile memory.

In another aspect, the invention provides an event monitoring solenoid system. An embodiment of such a system includes a device with an event monitoring solenoid connected to the device to exert an actuation force upon the device. The event monitoring solenoid includes a housing and a coil carried by the housing. The event monitoring solenoid also includes an armature movable relative to the housing. The solenoid also includes an event monitoring module situated in the housing. The event monitoring module is configured to monitor and wirelessly communicate information relating to at least one operational state of the event monitoring solenoid. The system also includes a remote user application. The remote user application is configured to receive the information relating to the at least one operational state from the event monitoring module.

In an embodiment according to this aspect, the system also includes a connection detection arrangement, particularly in the solenoid. The at least one operational state comprises an installation state of the event monitoring solenoid. The connection detection arrangement is in operable communication with the event monitoring module to communicate information indicative of the installation state of the event monitoring solenoid. The event monitoring module includes an installation supervision monitor. The installation supervision monitor is in operable communication with the connection detection arrangement to receive information sent by the connection detection arrangement.

In an embodiment according to this aspect, the system also includes an armature detection arrangement, particularly in the solenoid. The at least one operational state comprises a position of the armature. The armature detection arrangement is in operable communication with the event monitoring module to communicate information indicative of the position of the armature of the event monitoring solenoid. The event monitoring module includes a firing pin state monitor. The firing pin state monitor is in operable communication with the armature detection arrangement to receive information from the armature detection arrangement.

In an embodiment according to this aspect, the event monitoring module includes a coil voltage monitor and a coil current monitor each of which are configured to monitor the electrical power supply to the coil. The event monitoring module can also include at least one of a mechanical shock monitor and an ambient temperature sensor. The event monitoring module can also include a wireless transmitter configured to transmit information relating to the operational state wirelessly to the remote user application.

In an embodiment according to this aspect, the event monitoring module includes local memory for storing information relating to the at least one operational state.

In yet another aspect, the invention provides a method for monitoring an event of a solenoid. An embodiment of such a method includes detecting at least one operational state of the solenoid. The method also includes communicating information relating to the at least one operational state to an event monitoring module located in a housing of the solenoid. The method also includes wirelessly transmitting the information relating to the at least one operational state to a remote user application.

In an embodiment according to this aspect, the step of detecting includes using a sensor comprising at least one of a connection detection arrangement, and armature detection arrangement, a current monitor, a voltage monitor, a mechanical shock monitor, and an ambient temperature monitor.

In an embodiment according to this aspect, the method also includes storing the information relating to the at least one operational state in non-volatile memory located in the event monitoring module.

In an embodiment according to this aspect, the step of wirelessly transmitting the information relating to the at least one operational state includes wirelessly transmitting the information to a remote server for subsequent transmission to the remote user application.

In an embodiment according to this aspect, the step of wirelessly transmitting the information relating to the at least one operational state includes wirelessly transmitting the information directly to a device on which the user application is installed.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective view of an exemplary embodiment of a solenoid actuator and associated system according to the teachings herein;

FIG. 2 is a cross section of the solenoid of FIG. 1;

FIG. 3 is another cross section of the solenoid of FIG. 1; and

FIG. 4 is a schematic view of a communications module of the solenoid of FIG. 1.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

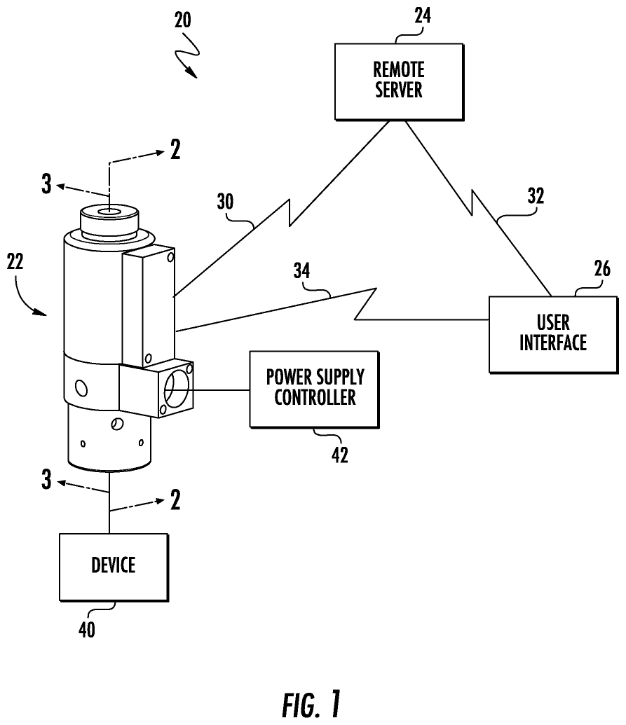

Turning now to the drawings, FIGS. 1-4 illustrate an embodiment of an event monitoring solenoid and system which may be utilized in a method according to the teachings herein. The event monitoring solenoid includes an on-board, i.e. local, event monitoring module. The event monitoring module is operable to monitor a variety of events also referred to herein as operational states of the solenoid, such as electrical power supplied to the coil of the solenoid, firing pin position, device connection fidelity, temperature, mechanical shock, etc.

Turning now to FIG. 1, an event monitoring solenoid system 20 is shown in FIG. 1. System 20 includes an event monitoring solenoid 22, and a remote user interface 26 (also referred to herein as a remote user application). As will be explained in greater detail below, event monitoring solenoid 22 includes an event monitoring module which may communicate wirelessly with a remote server 24 via schematically illustrated communications link 30. This remote server 24 may then communicate wirelessly or via a wired connection shown schematically as communication link 32 with user interface 26. Alternatively, event monitoring solenoid 22 may communicate directly with user interface 26. In either case, such a system advantageously allows for the communication of various events (also referred to herein as operational states) of event monitoring solenoid 22. Such events may be current operating conditions or changes in operating conditions.

Indeed, such events may, for example, be coil voltage amplitude or coil current amplitude. Such events may also include armature position, mechanical shock, temperature, solenoid installation, or pressure. Event monitoring solenoid 22 may transmit information relating to any one of the foregoing operational states. Indeed, event monitoring solenoid 22 may be scaled up or down to include various sensing componentry to transmit any number of parameters or operational states of event monitoring solenoid 22.

Still referring to FIG. 1, system 20 also includes a device 40 which event monitoring solenoid 22 connects to. Device 40 may, for example, be a pressurized tank of fluid or gas. In such a configuration, event monitoring solenoid 22 is operable to open and close a valve associated with device 40 to allow such fluid or gas to flow therefrom. Additionally, system 20 may also include a power supply and controller module 42 for providing power and control signals to event monitoring solenoid 22. For example, power supply and controller module 42 may be a building control panel used to control a variety of building systems and actuators, e.g. dampers and air duct systems, fire extinguishing systems, etc. Power supply and controller module 42 is optional to system 20 as it is also envisioned that event monitoring solenoid 22 may also incorporate its own internal power supply or simply be powered directly via direct connection to an existing electrical system.

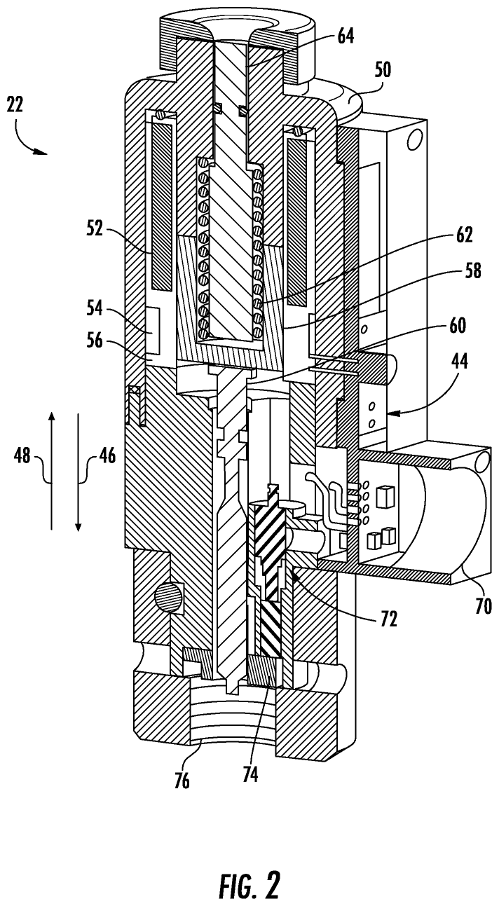

Turning now to FIG. 2, event monitoring solenoid includes an event monitoring module 44 housed within a housing 50 of event monitoring solenoid 22, or housed in a separate housing attached to housing 50. Indeed, event monitoring module 44 may be attached to any portion of event monitoring solenoid 22. Event monitoring module 44 includes all of the componentry necessary to interpret signals relating to operational states of event monitoring solenoid 22, recording such information, and transmitting such information. As such, event monitoring module 44 includes all of the necessary firmware, software, and hardware to achieve these functions.

Event monitoring solenoid 22 also includes a coil 52, a single or multi-piece armature, which in this case is illustrated as a multi-piece armature including a base element 58 with a firing pin 60 extending from an end of base element 58. Event monitoring solenoid 22 also includes a plurality of permanent magnets 54. Permanent magnets 54 provide a magnetic field within which base element 58 is magnetically attracted to housing 50. This magnetic attraction is strong enough that a biasing element 62 positioned between housing 50 and base element 58 cannot dislodge or remove base element 58 from its contact with housing 50. However, once coil 52 is energized, the magnetic field produced by permanent magnets 54 is reduced such that biasing element 62 can bias base element 58 and firing pin 60 downward in linear direction 46 ultimately to provide an actuating force to a device connected to event monitoring solenoid 22. To return firing pin 60 and base element 58, the same may be manually reset, or reset by reversing the polarity through coil 52 to increase the strength of the magnetic field. The method of resetting event monitoring solenoid 22 will be governed by the type of solenoid utilized.

With the above general description in mind, those of ordinary skill in the art will readily recognize that the illustrated embodiment shown is a latching solenoid. However, event monitoring module 44 may be incorporated with any known type of solenoid. As such, the description herein of event monitoring solenoid 22 should be taken by way of example only. As only one example of many, event monitoring solenoid may take the same mechanical configuration as that shown and described in U.S. Pat. No. 9,714,718 to Rogala et al. titled “Sensor for Connection Detection and Actuator including same,” the teachings and disclosure of which are incorporated by reference in their entirety herein.

Event monitoring solenoid 22 includes a variety of sensors which are disposed remote from event monitoring module 44 or disposed internally within event monitoring module 44 which are used for monitoring the various operational states of event monitoring solenoid 22.

For example, event monitoring solenoid 22 may include a connection detection arrangement which includes a plunger switch 72 that is acted upon by a disk 74. Disk 74 situated in proximity to thread 76 of event monitoring solenoid 22. As event monitoring solenoid 22 is threaded onto a valve or other device 40, disk 74 is depressed which in turn depresses plunger switch 72. Examples of either of the foregoing configurations may be readily seen in U.S. Pat. No. 9,714,718. It should be noted, however, that the “connection detection arrangement” in this context could be any device, sensor, or other configuration useful for determining when event monitoring solenoid 22 is attached to another device.

The signal produced by the connection detection arrangement is transmitted to event monitoring module 44 for subsequent recording and/or transmission as described below.

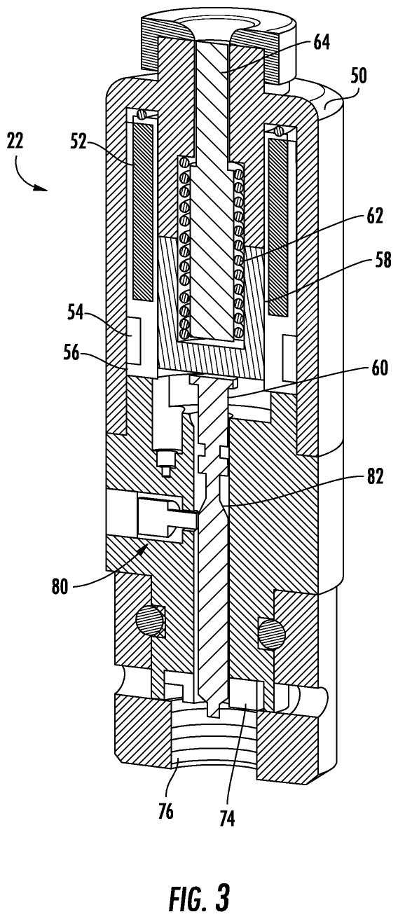

FIG. 3 illustrates another cross-section of event monitoring solenoid 22. In this view, an armature detection arrangement in the form of plunger switch 80 is illustrated. Plunger switch 80 acts against firing pin 82 to detect a position thereof. More specifically, firing pin 82 includes a ramped and narrowed portion 82. As firing pin 60 moves downward in linear direction 46 (See FIG. 2) plunger switch 80 follows this ramped and narrowed surface 82 in a cam-follower type arrangement. This produces a signal indicative of a position of firing pin 60. This signal is communicated to event monitoring module 44. This signal may be indicative of an end of travel of firing pin 60. Alternatively, plunger switch 80 could function as a force sensor may also be provided which detects a force exerted by base element 58, also indicative of the end of travel thereof. In either case, this signal is communicated to event monitoring module 44 for subsequent recording and/or transmission. It should be noted, however, that the “armature detection arrangement” in this context could be any device, sensor, or other configuration useful for determining the position of firing pin 60 and/or base element 58.

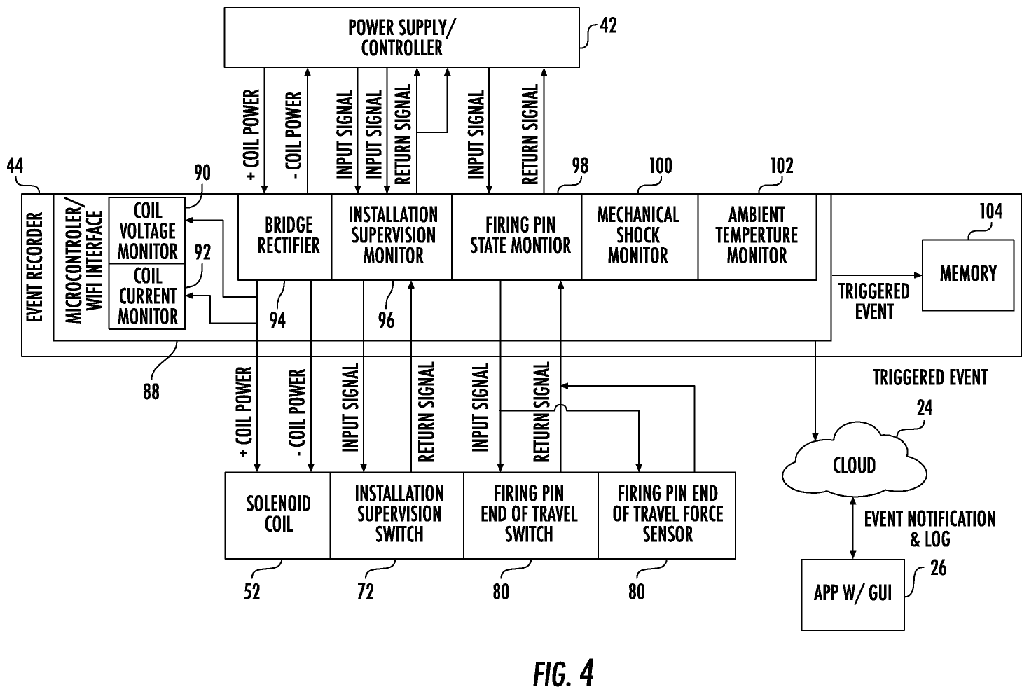

Turning now to FIG. 4, the event monitoring module 44 will be described in greater detail. In general, event monitoring module includes a microcontroller 88 with a plurality of modules. Event monitoring module also includes a wireless transmitter (denoted generally in FIG. 4 as a WIFI interface). This wireless transmitter emit and/or receive wireless signals which broadly speaking may be AM signals, FM signals, microwave signals, combinations thereof, or any other suitable type of wireless signal, using any known communication protocol, e.g. wife, Bluetooth, cellular, conventional radio, near field communication, etc.

Event monitoring module also includes a local memory element 104, which may for example be non-volatile memory. This local memory element 104 stores information relating to the various operational states observed by microcontroller 88. This local memory element 104 may be used to store the information prior to sending such information via the wireless transmitter. Alternatively, wireless transmitter may operate independently of local memory element 104. In such a configuration, not only can event monitoring module 44 send information to a remote user application 26, it can also save the same information locally for later access.

The microcontroller 88 is configured such that it presents a number of modules (also referred to as monitors) which are described below. These modules may communicate with local memory element 104 in order to store information relating to operational states of event monitoring solenoid 22 and/or may communicate with the wireless transmitter in order to wirelessly transmit information relating to the operational states of event monitoring solenoid 22. The communication of these modules with local memory element 104 and the wireless transmitter may be direct or via additional control circuitry or elements. Microcontroller 88 includes all software, hardware, and firmware necessary to achieve either communication scheme. Further, microcontroller 88 includes all the hardware, software, and firmware necessary to include additional information with the information relating to the operational state, e.g. a date and time stamp, duration, magnitude, etc.

Turning now to the various modules, microcontroller 88 includes a coil voltage monitor 90 and a coil current monitor 92. These devices monitor the electrical power supplied to coil 52. As illustrated in FIG. 4, monitor power delivered to coil 52 after the power has been supplied by power supply and controller 42 and passed through a bridge rectifier 94 of microcontroller 88. Bridge rectifier 94 is used for reverse polarity protection of coil 52.

Each monitor 90, 92 is configured recognize and generate a signal upon a triggered event, e.g. a preselected operational state. This operational state may be a threshold current or voltage value, of a change in current or voltage value. Upon the occurrence of reaching such a threshold or change in value, microcontroller 88 is operable to send information via the wireless transmitter and/or save the information in local memory element 104.

Microcontroller 88 also includes an installation supervision monitor 96. This installation supervision monitor 96 is in communication with the above described connection detection arrangement. Installation supervision monitor 96 passively monitors the signal from the connection detection arrangement for a change in state. In other words, installation supervision monitor 96 recognizes when event monitoring solenoid 22 is installed or removed from a device 40 (see FIG. 1). Upon the occurrence of detecting such a change in state, microcontroller 88 is operable to send information via the wireless transmitter and/or save the information in local memory element 104.

Microcontroller 88 also includes a firing pin state monitor 98. Firing pin state monitor 98 is in communication with the above described armature detection arrangement 80, which as discussed above may be an end of travel switch, or an end of travel force sensor. Firing pin state monitor 98 passively monitors the signal from armature detection arrangement 80 for a change in state. Firing pin state monitor 98 recognizes when firing pin 60 has reached its end of travel. Upon the occurrence of such a change in state, microcontroller 88 is operable to send information via the wireless transmitter and/or save the information in local memory element 104.

Microcontroller 88 also includes a mechanical shock monitor 100. Unlike the modules already described, mechanical shock monitor 100 is not in communication with a signal from another device or source. Rather, mechanical shock monitor may be embodied in one non-limiting example as a 3-axis accelerometer. Upon exceeding a preset g-force load in any of these 3 axes, microcontroller 88 is operable to send information via the wireless transmitter and/or to save the information in local memory element 104.

Microcontroller 88 also includes an ambient temperature sensor 102. This temperature sensor 102 monitors the temperature surrounding event monitoring solenoid 22. If this temperature exceeds a preset value, microcontroller 88 is operable to send information via the wireless transmitter and/or save the information in local memory element 104.

As indicated above, microcontroller 88 is operable to send a wireless signal via its wireless transmitter directly to a user application 26, or indirectly to user application 26 using an intermediary connection such as a remote server 24 (illustrated generally as the cloud in FIG. 4). In either case, microcontroller sends information regarding one or more operational states of event monitoring solenoid 22 wirelessly. This has a significant advantage over prior designs which at best allow for local collection of basic information of a solenoid via a wired connection at a control panel in proximity or on site with the solenoid. Indeed, this system allows for remote access to event monitoring solenoid 22 to monitor various operational states recorded by the same.

Indeed, in one particularly advantageous arrangement, a user may have user application 26 installed on their mobile device. The user may assess operational states, diagnose problems, and understand historical data pertaining to the operation of event monitoring solenoid 22 by simply being in range of event monitoring solenoid 22. In this configuration, event monitoring solenoid 22 could communicate directly with the mobile device via any known protocol, e.g. near field communication.

Alternatively, event monitoring solenoid may connect to a remote server 24 such as a router of a wifi network in range of event monitoring solenoid 22. The user could connect their mobile device to this same wifi network, and communication between user application 26 and event monitoring solenoid 22 could be achieved. From the above, it will be recognized that remote server 24 may be embodied as any intermediary device and/or software providing for communication to remote user application 26 from event monitoring solenoid 22.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An event monitoring solenoid, comprising:
a housing;
a coil carried by the housing;
an armature movable relative to the housing;
an event monitoring module situated on the housing, the event monitoring module configured to monitor and record information relating to at least one operational state of the solenoid in a local memory element of the event monitoring module.

2. The event monitoring solenoid of claim 1, further comprising a connection detection arrangement and wherein the at least one operational state comprises an installation state of the event monitoring solenoid, the connection detection arrangement in operable communication with the event monitoring module to communicate information indicative of the installation state of the event monitoring solenoid.

3. The event monitoring solenoid of claim 2, wherein the event monitoring module includes an installation supervision monitor, the installation supervision monitor in operable communication with the connection detection arrangement to receive information sent by the connection detection arrangement.

4. The event monitoring solenoid of claim 3, wherein the connection detection arrangement comprises one of a plunger switch or a pressure sensitive film.

5. The event monitoring solenoid of claim 1, further comprising an armature detection arrangement and wherein the at least one operational state comprises a position of the armature, the armature detection arrangement in operable communication with the event monitoring module to communicate information indicative of the position of the armature of the event monitoring solenoid.

6. The event monitoring solenoid of claim 5, wherein the event monitoring module includes a firing pin state monitor, the firing pin state monitor in operable communication with armature detection arrangement.

7. The event monitoring solenoid of claim 6, wherein the armature detection arrangement includes one of a plunger switch or a force sensor.

8. The event monitoring solenoid of claim 1, wherein the event monitoring module includes a coil voltage monitor and a coil current monitor each of which are configured to monitor the electrical power supplied to the coil.

9. The event monitoring solenoid of claim 1, wherein the event monitoring module includes at least one of a mechanical shock monitor and an ambient temperature sensor.

10. The event monitoring solenoid of claim 1, wherein the event monitoring module includes a wireless transmitter configured to transmit information relating to the at least one operational state wirelessly to a remote user application.

11. The event monitoring solenoid of claim 1, wherein the local memory element is non-volatile memory.

12. An event monitoring solenoid system, the system comprising:
a device;
an event monitoring solenoid connected to the device exert an actuation force upon the device, wherein the event monitoring solenoid includes:
a housing;
a coil carried by the housing;
an armature movable within the housing; and
an event monitoring module situated in the housing, the event monitoring module configured to monitor and wirelessly communicate information relating to at least one operational state of the event monitoring solenoid;
a remote user application, the remote user application configured to receive the information relating to the at least one operational state from the event monitoring module.

13. The event monitoring solenoid system of claim 12, further comprising a connection detection arrangement and wherein the at least one operational state comprises an installation state of the event monitoring solenoid, the connection detection arrangement in operable communication with the event monitoring module to communicate information indicative of the installation state of the event monitoring solenoid.

14. The event monitoring solenoid of claim 13, wherein the event monitoring module includes an installation supervision monitor, the installation supervision monitor in operable communication with the connection detection arrangement to receive information sent by the connection detection arrangement.

15. The event monitoring solenoid of claim 12, further comprising an armature detection arrangement and wherein the at least one operational state comprises a position of the armature, the armature detection arrangement in operable communication with the event monitoring module to communicate information indicative of the position of the armature of the event monitoring solenoid.

16. The event monitoring solenoid of claim 15, wherein the event monitoring module includes a firing pin state monitor, the firing pin state monitor in operable communication with armature detection arrangement to receive information form the armature detection arrangement.

17. The event monitoring solenoid of claim 12, wherein the event monitoring module includes a coil voltage monitor and a coil current monitor each of which are configured to monitor the electrical power supplied to the coil.

18. The event monitoring solenoid of claim 12, wherein the event monitoring module includes at least one of a mechanical shock monitor and an ambient temperature sensor.

19. The event monitoring solenoid of claim 1, wherein the event monitoring module includes a wireless transmitter configured to transmit information relating to the operational state wirelessly to the remote user application.

20. The event monitoring solenoid system of claim 1, wherein the event monitoring module includes local memory for storing information relating to the at least one operational state.

21. A method for monitoring an event of a solenoid, the method comprising:
detecting at least one operational state of the solenoid;
communicating information relating to the at least one operational state to an event monitoring module located in a housing of the solenoid; and
wirelessly transmitting the information relating to the at least one operational state to a remote user application.

22. The method of claim 21, wherein the step of detecting includes using a sensor comprising at least one of a connection detection arrangement, an armature detection arrangement, a current monitor, a voltage monitor, a mechanical shock monitor, and an ambient temperature monitor.

23. The method of claim 21, further comprising storing the information relating to the at least one operation state in non-volatile memory located in the event monitoring module.

24. The method of claim 21, wherein the step of wirelessly transmitting the information relating to the at least one operational state includes wirelessly transmitting the information to a remote server for subsequent transmission to the remote user application.

25. The method of claim 24, wherein the step of wirelessly transmitting the information relating to the at least one operational state includes wirelessly transmitting the information directly to a device on which the user application is installed.
